(19) United States
(12) Patent Application Publication
(10) Pub. No.: US 2005/0284254 A1
(43) Pub. Date: Dec. 29, 2005

(54) Balance shaft

(75) Inventors: Scott Hawkins, Osseo, MI (US); Jerry L. Zabonick, Coldwater, MI (US)

Correspondence Address: WOOD, HERRON & EVANS, LLP, 2700 CAREW TOWER, 441 VINE STREET, CINCINNATI, OH, 45202, US

(73) Assignee: Eagle-Picher Industries, Inc.

(21) Appl. No.: 10/877,711

(22) Filed: Jun. 25, 2004

(51) Int. Cl. F16C 3/04

(52) U.S. Cl. 74/603

(57) ABSTRACT

A balance shaft for an engine comprises an elongate member defining a longitudinal axis and having first and second ends. A first counterweight is adjacent the first end and a second counterweight is adjacent the second end and positioned on opposite sides of the longitudinal axis. Each of the counterweights includes a pair of weight portions that are mirror images of each other across the longitudinal axis. Each weight portion includes a first generally planar surface extending in the longitudinal direction, a second generally planar surface inclined with respect to the first surface, and a third generally planar surface inclined with respect to the first and second surfaces. The inclined relation between the three surfaces controls the location of the gravitational center of each counterweight so that when the balance shaft rotates about the longitudinal axis, a couple moment is provided that counteracts the unbalance moment generated by the engine.

### FIELD OF THE INVENTION

The invention relates to a balance shaft, and in particular to a balance shaft provided with counterweights for cancelling the unbalance moment produced in reciprocating engines.

### BACKGROUND OF THE INVENTION

Automotive designers are constantly striving to improve the level of comfort in the automobile for both driver and passengers. It is well known, for example, that reciprocating engines have inherent design imbalances that generate undesired effects, such as engine vibration and noise, which contribute to driver/passenger fatigue and irritation as well as engine wear and other structural failures. As a result, automotive designers and manufactures have for some time utilized balance shafts to reduce or cancel the inherent imbalances generated in the reciprocating engine.

It is known that multi-cylinder motor vehicle engines typically generate two types of imbalance forces. These are generally referred to as shaking forces and unbalance moments. Depending on the particular type of design, an engine may generate both types of imbalance forces or only one type of imbalance force. For instance, in-line engine designs, typical of many four-cylinder engines, generally generate both types of imbalance forces while other designs, such as the V-6 design, generate only unbalance moments. In either case, however, one or a pair of balance shafts may be used to cancel or reduce the shaking forces and unbalance moments so as to reduce the vibration and noise experienced by the driver and/or passengers.

By way of example, and as is known in the art, the 90-degree V-6 engine, which has two cylinder banks each containing three cylinders and spaced 90 degrees apart, produce imbalance forces in the form of an unbalance moment. To counteract the unbalance moment, one balance shaft may be used, which when rotated, produces no net shaking force but generates a moment that cancels the unbalance moment caused by the reciprocating pistons. The balance shaft for these engines typically includes an elongate member having two spaced apart counterweights coupled to opposed sides of the elongate member. The counterweights are equal in weight and shape so that only a pure moment is generated on the crankcase of the engine.

The overall design of the balance shaft, however, is not only guided by dynamic considerations, i.e., counteracting the imbalance forces, but are guided by other factors, such as space, weight and structural limitations. For instance, it is desired to minimize the weight of the balance shaft so as to reduce the overall weight of the engine. The reduction in weight, however, must be accomplished without diminishing the structural requirements, such as the bending rigidity and load bearing capabilities, of the balance shaft. As a result, automotive designers desire balance shafts that not only satisfy their dynamic criteria but also have optimized strength-to-weight ratios. One such balance shaft is disclosed in U.S. Pat. No. 5,857,388 and shows two counterweights on opposed sides of an elongate member. To reduce the weight of the balance shaft, the counterweights have surfaces that form hyperbolic curves. Additionally, a connecting portion extending between the two counterweights has an I-shape with larger upper and lower portions and recessed central portions.

There is, however, a continuing need for balance shafts that not only satisfy the dynamic criteria, by canceling or reducing the imbalance forces inherent in a particular engine design, but also have improved strength-to-weight ratios.

### SUMMARY OF THE INVENTION

According to the present invention, a balance shaft for a reciprocating engine is provided that produces a couple moment to counteract the unbalance moment generated by the reciprocating engine. To this end, the balance shaft comprises an elongate member having first and second opposed ends extending in a longitudinal direction and defining a longitudinal axis. The elongate member is adapted to rotate about the longitudinal axis. The balance shaft further includes a first counterweight adjacent the first end and a second counterweight adjacent the second end. The counterweights are positioned on opposite sides of the longitudinal axis and have a gravitational center on opposite sides of the longitudinal axis. This configuration is advantageous for producing a couple moment when the balance shaft is rotated so as to cancel the unbalance moment caused by the reciprocation of the engine pistons. Each of the counterweights includes a pair of weight portions wherein one weight portion is the mirror image of the other weight portion across the longitudinal axis. Each weight portion comprises a first elongate generally planar surface extending generally in the longitudinal direction, a second generally planar surface inclined with respect to the first surface, and a third generally planar surface inclined with respect to the first and second surfaces. The first generally planar surface may be inclined in the longitudinal direction. Advantageously, the inclined relation between the three generally planar surfaces is configured to control or selectively position the gravitational center of each of the first and second counterweights.

In one embodiment, the balance shaft includes a first and second bearing surface adjacent the first and second ends respectively. The bearing surfaces support the balance shaft in the engine and allow the shaft to freely rotate about the longitudinal axis. The elongate member includes a connecting portion extending between the first and second counterweights. The connecting portion includes a first flange adjacent the first counterweight and a second flange adjacent the second counterweight such that the cross section of the connecting portion is generally T-shaped. The connecting member may include a central hub so that the first flange extends between the first counterweight and the hub in an arcuate manner and the second flange extends between the second counterweight and the hub also in an arcuate manner. To provide additional strength, the elongate member further includes a first stiffening bead extending along the elongate member opposite the first counterweight and a second stiffening bead extending along the elongate member opposite to the second counterweight.

By virtue of the foregoing, there is thus provided an improved engine balance shaft having increased strength, a reduction in weight, and thus an overall increase in the strength-to-weight ratio as comparted to current balance shafts.

The features and objectives of the present invention will become more readily apparent in light of the following detailed description and drawings in which:

### BRIEF DESCRIPTION OF THE DRAWINGS

FIG. 1 is a front elevation view of an automobile engine incorporating a balance shaft according to the invention;

FIG. 2 is a side elevational view of the engine shown in FIG. 1;

FIGS. 3A and 3B are conceptualized diagrams of rotating balance shafts;

FIG. 4 is a perspective view of a balance shaft according to the invention;

FIG. 5 is an enlarged partial perspective view of the balance shaft of FIG. 4;

FIG. 6 is a side elevational view of the balance shaft shown in FIG. 4;

FIG. 7 is a partial top plan view of the balance shaft shown in FIG. 4;

FIGS. 8-10 are cross-sectional views of the balance shaft shown in FIG. 6 and being taken along lines 8-8, 9-9 and 10-10, respectively, in FIG. 6.

### DETAILED DESCRIPTION

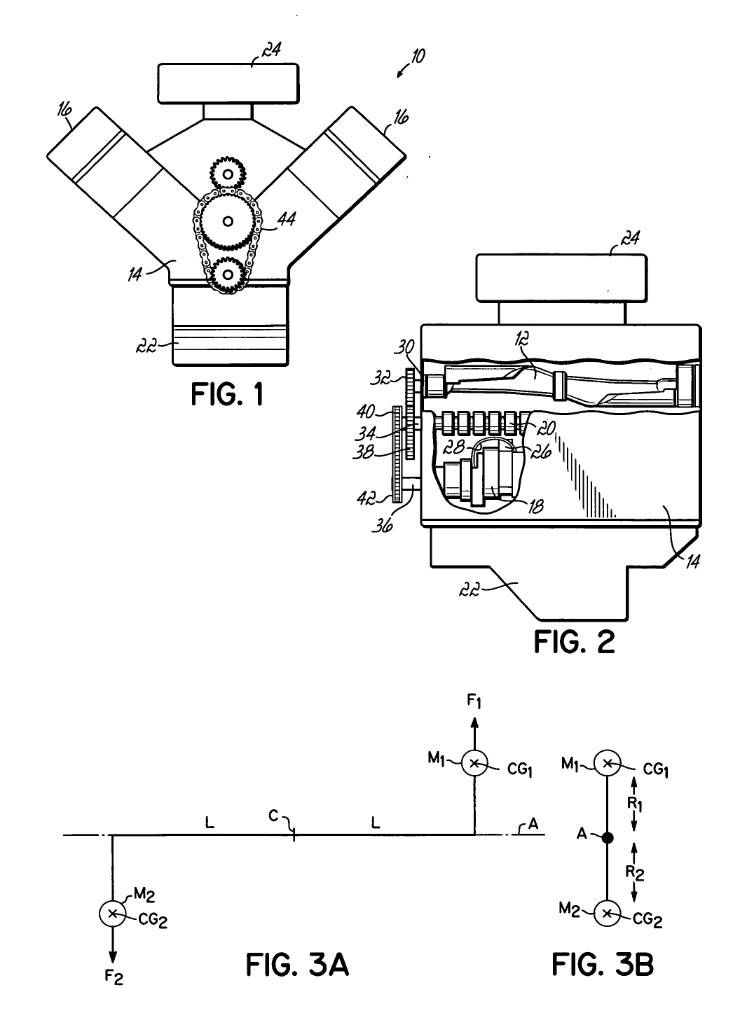

The balance shaft of the present invention may be used in any type of automobile engine where it is necessary or desirable to reduce or cancel imbalance forces, such as shaking forces and unbalance moments, inherent in the design and operation of the engine. A representative engine in which the present invention may be used is shown in FIGS. 1 and 2 and generally referred to by reference numeral 10.

The engine 10 is a V-6 engine with two sets of three cylinders spaced 90 degrees apart. These engines, due to their structure and geometry, do not generate any shaking forces but do generate an unbalanced moment which rotates in the opposite direction of the crankshaft. Consequently, this type of engine can significantly benefit from a counter-rotating balance shaft that generates an opposite couple moment. A balance shaft 12 according to the present invention may be incorporated into engine 10 as shown in FIGS. 1 and 2. The balance shaft 12 is configured to generate a couple moment to oppose that caused by the engine so as to reduce or cancel out any imbalances.

The engine 10 in which that balance shaft 12 is situated generally comprises a cylinder block 14, a pair of cylinder heads 16, a crankshaft 18, a camshaft 20, an oil pan 22 and an air cleaner 24. A plurality of pistons 26 are positioned in cylinders 28 and connected to crankshaft 18 by conventional means. A driveshaft 30 coupled to the balance shaft 12 protrudes outside the front of the cylinder block 14 and has a drive gear or sprocket 32 attached thereto. The gear 32 is oriented and attached to the driveshaft 30 by conventional means. The camshaft 20 and crankshaft 18 also have driveshafts 34, 36 respectively coupled thereto, which protrude outside the front of the cylinder block 14. Member 34 of camshaft 20 is secured to drive gear 38 and sprocket 40. Member 36 of crankshaft 18 is secured to drive sprocket 42. Sprockets 40 and 42 are connected by a conventional drive chain or tooth timing belt 44. Drive gear 38 is meshed with gear 32 on the balance shaft 12.

Sprockets 40 and 42 are both rotated in the same direction by the drive chain or tooth timing belt 44, as shown in FIG. 1. The respective sizes and diameters of sprockets 40 and 42 are such that the crankshaft 18 rotates at twice the speed of camshaft 20. The meshing of gears 32 and 38 causes the balance shaft 12 to rotate in a direction opposite to that of the crankshaft 18 and thus counteract the unbalance couple caused by the engine 10. The size and diameter of the gears 32 and 44 determine the rotational speed of the balance shaft 12. Typically, the balance shaft 12 is rotated at the same speed as crankshaft 18. Those of ordinary skill in the art will recognize, however, that gears 32, 44 may be configured such that balance shaft 12 is rotated at speeds different from crankshaft 18. For instance, for some engine designs, the balance shaft 12 may be rotated at half the speed of crankshaft 18.

The engine 10 as thus far described may be considered to be conventional and, for that reason, components which are conventional will not be described further inasmuch as their construction and operation will be known to those having ordinary skill in the art.

Balance shafts typically comprise a pair of longitudinally spaced weights on opposed sides of a central axis, around which the weights rotate. A connecting portion connects the two weights. This configuration is conceptualized in FIGS. 3A and 3B which shows the weights as point masses M₁ and M₂ having gravitational centers CG₁ and CG₂ respectively, and rotating about central axis A. The inertial forces F₁ and F₂ on each point mass M₁ and M₂ are proportional to the mass (weight) multiplied by the radial distance R₁ and R₂ between the central axis A and the centers of gravity CG₁ and CG₂. Because the V-6 engine generates no shaking forces, then by performing a radial force balance, one gets that R₁W₁=R₂W₂, where W₁ and W₂ are the weights of the two point masses M₁ and M₂, otherwise a net force would be generated. A zero radial force balance would occur, for example, if both point masses M₁ and M₂ had the same weight and a center of gravity offset from the central axis A by the same amount. Nevertheless, as shown in FIG. 3A, the conceptualized rotating balance shaft produces a net moment about a central point C located midway between the gravitational centers CG₁ and CG₂. This is a couple moment, which can be calculated by convention methods and expressed as:
M_{c}=LR₁W₁+LR₂W₂, (1)
where L is half the distance between the centers of gravity CG₁ and CG₂. To cancel out the imbalance in the engine, the balance shaft is designed such that Mc is approximately equal to the unbalance moment generated by the engine. In this equation, the product LR₁ and LR₂ are controlled by the location of the gravitational centers CG₁ and CG₂ of each point mass. Thus, it becomes important to control the location of the center of gravity.

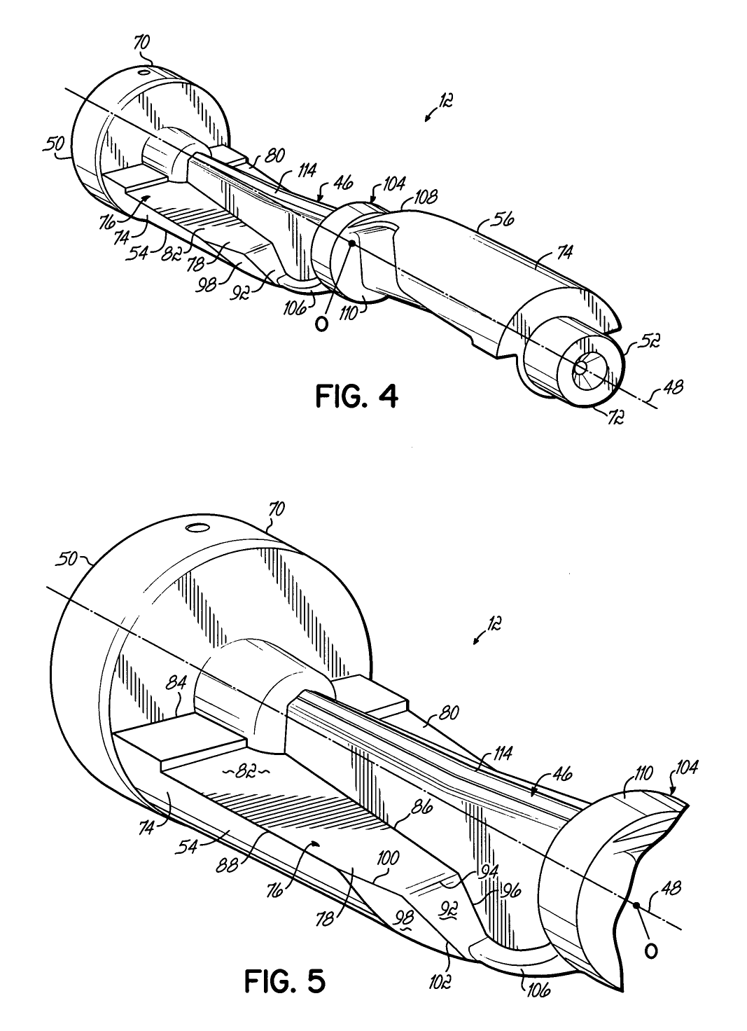

A balance shaft, generally shown at 12, in accordance with the invention is shown in FIGS. 4-7. As shown in these figures, the balance shaft 12 comprises an elongate member 46 that extends in a longitudinal direction and defines a longitudinal axis 48. When balance shaft 12 is positioned in the engine 10, the shaft 12 rotates around the longitudinal axis 48. The elongate member 46 terminates at first and second ends 50, 52, respectively. A first counterweight 54 is positioned adjacent the first end 50 of the elongate member 46 and is configured to be on one side of longitudinal axis 48. For instance, as shown in FIGS. 4 and 5, the first counterweight 54 is below the longitudinal axis 48.

A second counterweight 56 is positioned adjacent the second end 52 of the elongate member 46 and configured to be on the opposite side of the longitudinal axis 48. Again, as shown in FIGS. 4 and 5, the second counterweight 56 is above the longitudinal axis 48. Thus, the first and second counterweights 54, 56 are separated by 180 degrees in a circumferential direction around the longitudinal axis 48. The first and second counterweights 54, 56 each have a gravitational center, generally shown at 58, 60, respectively, that are offset from the longitudinal axis 48. The gravitational centers 58, 60 are further separated from a central point O. As shown in these figures, the first and second counterweights 54, 56 are of equal weight and are of the same shape. In this way, the radial offsets 62, 64 of the gravitational centers 58, 60 are equal and the distances 66, 68 from the central point O is likewise equal. As mentioned above, this produces a couple moment around the central point O that counteracts the uncouple balance caused by the reciprocation of the pistons 26. Those of ordinary skill in the art will recognize, however, that the weights and/or shapes of the first and second counterweights 54, 56 may be different and configured to reduce or cancel shaking imbalances as well as moment imbalances of a particular engine design. The embodiment shown and described is for a V-6 engine that produces only a moment imbalance thus allowing the counterbalances 54, 56 to be of equal weight and similar in shape.

The elongate member 46 further includes a first bearing portion 70 adjacent the first end 50 and a second bearing portion 72 adjacent the second end 52. The first and second bearing portions 70, 72 are adapted to fit within bearings (not shown) in cylinder block 14 so that the balance shaft 12 is coupled to engine 10 but is free to rotate about the longitudinal axis 48. Drive shaft 30 couples to the first bearing surface 70 and extends outside cylinder block 14 and connected to drive gear 32 as discussed above.

As shown in FIGS. 4-10, and perhaps best shown in FIG. 5, which shows an enlarged view of the first counterweight 54, each counterweight 54, 56 comprises a generally cylindrical portion 74 and an exposed surface, generally shown at 76, adjacent the longitudinal axis 48. The exposed portion 76 includes a pair of weight portions 78, 80 which are mirror images of each other across the longitudinal axis 48. In accordance with the invention, each weight portion 78, 80 is comprised of three generally planar surfaces that are inclined with respect to the other surfaces. Advantageously, the inclined relation between the three surfaces is adapted to selectively position the gravitational centers 58, 60 of each counterweight 54, 56. From a design consideration, the inclined relation may be configured so that the resulting couple moment balances the unbalance moment generated by the engine 10. Additionally the counterweights 54, 56 may be configured to have a generally low profile by spreading the counterweights 54, 56 along the longitudinal axis of balance shaft 12. For instance, each counterweight may have a relatively large axial length-to-diameter ratio, such as in the range of 1 to 3.

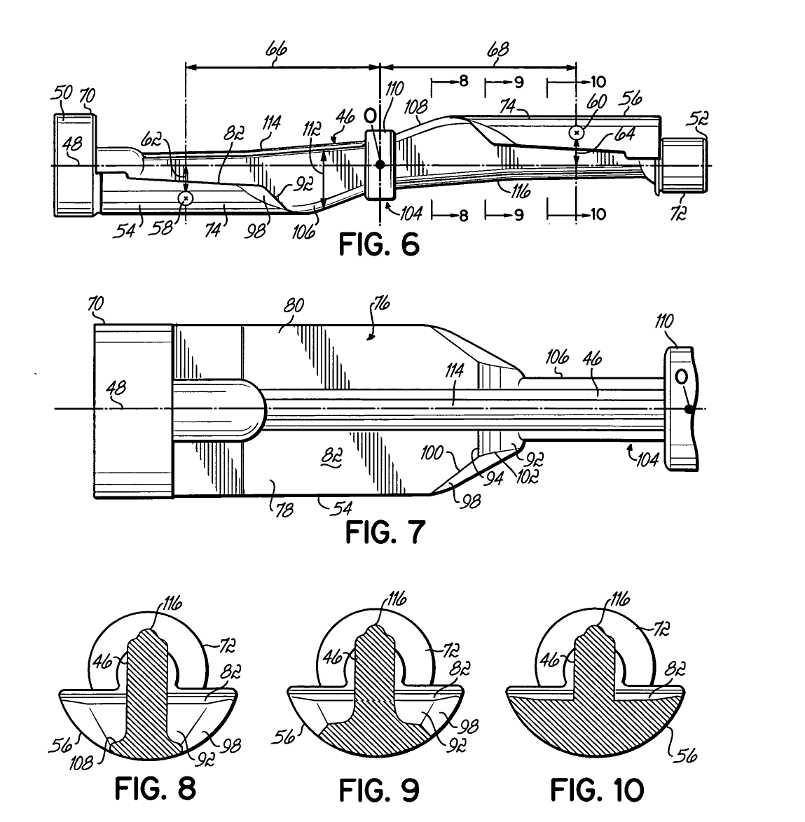

To this end, the exposed surface 76 includes a first elongate, generally planar surface 82 that extends generally in the longitudinal direction. As shown in FIG. 5, an outer end 84 adjoins the first bearing surface 70 and an inner side edge 86 adjoins the elongate member 46. The outer side edge 88 is generally parallel to the inner side edge 86. The inner end is configured as a tapered portion. The taper portion comprises a second generally planar surface 92 that is inclined with respect to the first surface 82. The first and second surfaces 82, 92 meet at a common edge 94. The inner side edge 96 of the second surface 92 adjoins the elongate member 46. The second surface 92 is inclined with respect to the first surface 82 such that as one moves toward the center point O along second surface 92, one moves away from the longitudinal axis 46 in one direction. For example, as shown in the specific configuration of FIG. 5, the second surface 92 is angled in a downward direction with respect to the first surface 82. The inclined relation between the first and second surfaces 82, 92 may clearly be seen in FIG. 6.

The taper portion of each weight portion 78, 80 further includes a third generally planar surface 98 that is inclined with respect to both the first surface 82 and second surface 92. The first and third surfaces 82, 98 meet at a common edge 100. Additionally, the second and third surfaces 92, 98 meet along common edge 102. The third surface 98 is configured such that as one moves toward the center point O along common edge 100, the distance between common edge 100 and the inner side edge 86 of first surface 82 decreases. Moreover, as one moves toward the center point O along common edge 102, the distance between common edge 102 and the inner side edge 96 of second surface 92 decreases. The third surface 98 is inclined with respect to the first and second surfaces 82, 92 in more than one direction. The taper of common edges 100, 102 can clearly be seen in FIG. 7.

Furthermore, and as shown in FIG. 6, the first generally planar surface 82 may be inclined in the longitudinal direction so that as one moves along first surface 82 toward center point O, the distance between the first surface 82 and the longitudinal axis 48 increases. Advantageously, by adjusting the inclination of the first, second and third generally planar surfaces 82, 92, 98, the gravitational centers 58, 60 of each counterweight 54, 56 may be selectively positioned so as to counteract the unbalance moment of the engine 10.

In further accordance with the present invention, the elongate member 46 includes a connecting portion 104 extending between the first and second counterweights 54, 56. The connecting portion 104 includes a first flange 106 adjacent the first counterweight 54 and extending in the longitudinal direction. In a likewise manner, the connecting portion 104 further includes a second flange 108 adjacent the second counterweight 56 and extending in the longitudinal direction. The first and second flanges 106, 108 are configured so that the connecting portion 104 between the two counterbalances 54, 56 has a substantially T-shaped cross section, as shown in FIG. 8. In the embodiment shown, the connecting portion 104 includes a central hub 110. The first flange 106 extends between the first counterweight 54 and the central hub 110 and the second flange 108 extends between the second counterweight 56 and the hub 110. To counteract the centrifugal forces generated by the counterweights 54, 56 as balance shaft 12 is rotated, the flanges 106, 108 are arcuately shaped in the longitudinal direction such that as one moves away from the central point O toward the counterweights 54, 56, the width 112 of the connecting portion 104 increases, as best shown in FIG. 6.

In further accordance with the present invention, and as shown in FIGS. 8-10, elongate member 46 includes a first stiffening bead 114 extending in the longitudinal direction on the opposite side of the elongate member 46 as the first counterweight 54. In a likewise manner, elongate member 46 further includes a second stiffening bead 116 extending in the longitudinal direction on the opposite side of the elongate member 46 as the second counterweight 56. The stiffening beads 114, 116 increase the overall strength of the balance shaft 12. The balance shaft 12, as herein described, advantageously allows automotive designers to selectively position the gravitational centers 58, 60 of the counterweights 54, 56 by manipulating the inclined relation of the three generally planar surfaces 82, 92, 98. Moreover, the configuration of the counterweights 54, 56 in conjunction with the configuration of the connecting portion 104 advantageously provides a balance shaft 12 that has an improved strength-to-weight ratio over current balance shaft designs.

While the present invention has been illustrated by a description of various preferred embodiments and while these embodiments have been described in considerable detail in order to describe the best mode of practicing the invention, it is not the intention of applicant to restrict or in any way limit the scope of the appended claims to such detail. Additional advantages and modifications within the spirit and scope of the invention will readily appear to those skilled in the art. The invention itself should only be defined by the appended claims, wherein

1. A balance shaft for an engine comprising:
an elongate member defining a longitudinal axis and having a first and second end, said elongate member adapted to rotate about the longitudinal axis; and
a first counterweight adjacent said first end and a second counterweight adjacent said second end, said first and second counterweights positioned on opposite sides of the longitudinal axis and having a gravitational center, said counterweights adapted to provide a couple moment that counteracts the unbalance moment generated by the engine,
each of said first and second counterweights including a pair of weight portions wherein one weight portion is the mirror image of the other weight portion across the longitudinal axis, each weight portion comprising:
a first elongated generally planar surface extending generally in the direction of the longitudinal axis;
a second generally planar surface inclined with respect to said first generally planar surface; and
a third generally planar surface inclined with respect to said first and second generally planar surface,
wherein the inclined relation between said first, second and third generally planar surfaces controls the position of the gravitational center of said first and second counterweights.

2. The balance shaft of claim 1, wherein said first elongated generally planar surface is inclined in the longitudinal direction.

3. The balance shaft of claim 1 further comprising:
a first bearing portion adjacent said first end and a second bearing portion adjacent said second end, said first and second bearing portions adapted to support said balance shaft in the engine.

4. The balance shaft of claim 1, wherein said first and second counterweights have the same weight.

5. The balance shaft of claim 4, wherein said first and second counterweights have the same shape.

6. The balance shaft of claim 1, wherein said elongate member includes a connecting portion extending between said first and second counterweights, said connecting portion comprising:
a first flange extending longitudinally along said elongate member and adjacent said first counterweight; and
a second flange extending longitudinally along said elongate member and adjacent said second counterweight,
said first and second flanges configured so that said connecting portion has a substantially T-shaped cross-section.

7. The balance shaft of claim 6, wherein said connecting portion further comprises:
a central hub wherein said first flange extends between said first counterweight and said hub and said second flange extends between said second counterweight and said hub.

8. The balance shaft of claim 6, wherein said first and second flanges are arcuate in the longitudinal direction.

9. The balance shaft of claim 1, wherein said elongate member includes a first stiffening bead extending longitudinally along said elongate member opposite to said first counterweight and a second stiffening bead extending longitudinally along said elongate member opposite to said second counterweight.

10. A balance shaft for a reciprocating engine adapted to counteract an unbalance moment generated by the engine, comprising:
an elongate member defining a longitudinal axis and having a first and second end, said elongate member adapted to rotate about the longitudinal axis; and
a first counterweight adjacent said first end and a second counterweight adjacent said second end, said first and second counterweights positioned on opposite sides of the longitudinal axis and having a gravitational center,
said elongate member defining a connecting portion extending between said first and second counterweights having a first flange adjacent said first counterweight and a second flange adjacent said second counterweight, said first and second flanges configured so that said connecting portion has a substantially T-shaped cross-section,
each of said first and second counterweights including a pair of weight portions wherein one weight portion is the mirror image of the other weight portion across the longitudinal axis, each weight portion comprising:
a first elongated generally planar surface extending generally in the direction of the longitudinal axis;
a second generally planar surface inclined with respect to said first generally planar surface; and
a third generally planar surface inclined with respect to said first and second generally planar surface,
wherein the inclined relation between said first, second and third generally planar surfaces controls the position of the gravitational center of said first and second counterweights.

11. The balance shaft of claim 10, wherein said first elongate generally planar surface is inclined in the longitudinal direction.

12. The balance shaft of claim 10 further comprising:
a first bearing portion adjacent said first end and a second bearing portion adjacent said second end, said first and second bearing portions adapted to support said balance shaft in the engine.

13. The balance shaft of claim 10, wherein said first and second counterweights have the same weight.

14. The balance shaft of claim 13, wherein said first and second counterweights have the same shape.

15. The balance shaft of claim 10, wherein said elongate member includes a first stiffening bead extending longitudinally along said elongate member opposite to said first counterweight and a second stiffening bead extending longitudinally along said elongate member opposite to said second counterweight.

16. A reciprocating engine comprising:
an engine block; and
a balance shaft rotatably coupled within said engine block, said balance shaft comprising:
an elongate member defining a longitudinal axis and having a first and second end, said elongate member adapted to rotate about the longitudinal axis; and
a first counterweight adjacent said first end and a second counterweight adjacent said second end, said first and second counterweights positioned on opposite sides of the longitudinal axis and having a gravitational center, said counterweights adapted to provide a couple moment that counteracts the unbalance moment generated by the engine,
each of said first and second counterweights including a pair of weight portions wherein one weight portion is the mirror image of the other weight portion across the longitudinal axis, each weight portion comprising:
a first elongated generally planar surface extending generally in the direction of the longitudinal axis;
a second generally planar surface inclined with respect to said first generally planar surface; and
a third generally planar surface inclined with respect to said first and second generally planar surface,
wherein the inclined relation between said first, second and third generally planar surfaces controls the position of the gravitational center of said first and second counterweights.

17. The balance shaft of claim 16, wherein said first elongated generally planar surface is inclined in the longitudinal direction.

18. The balance shaft of claim 16 further comprising:
a first bearing portion adjacent said first end and a second bearing portion adjacent said second end, said first and second bearing portions adapted to support said balance shaft in the engine.

19. The balance shaft of claim 16, wherein said first and second counterweights have the same weight.

20. The balance shaft of claim 19, wherein said first and second counterweights have the same shape.

21. The balance shaft of claim 16, wherein said elongate member includes a connecting portion extending between said first and second counterweights, said connecting portion comprising:
a first flange extending longitudinally along said elongate member and adjacent said first counterweight; and
a second flange extending longitudinally along said elongate member and adjacent said second counterweight,
said first and second flanges configured so that said connecting portion has a substantially T-shaped cross-section.

22. The balance shaft of claim 21, wherein said connecting portion further comprises:
a central hub wherein said first flange extends between said first counterweight and said hub and said second flange extends between said second counterweight and said hub.

23. The balance shaft of claim 22, wherein said first and second flanges are arcuate in the longitudinal direction.

24. The balance shaft of claim 16, wherein said elongate member includes a first stiffening bead extending longitudinally along said elongate member opposite to said first counterweight and a second stiffening bead extending longitudinally along said elongate member opposite to said second counterweight.
